(19) United States
(12) Patent Application Publication
(10) Pub. No.: US 2006/0118393 A1
(43) Pub. Date: Jun. 8, 2006

(54) Conveyor belt arrestor

(76) Inventor: Hubert de Villiers Barnard, Pretoria (ZA)

Correspondence Address: PAULEY PETERSEN & ERICKSON, 2800 WEST HIGGINS ROAD, SUITE 365, HOFFMAN ESTATES, IL, 60195, US

(21) Appl. No.: 10/525,117

(22) PCT Filed: Aug. 19, 2002
(86) PCT No.: PCT/IB02/03321

§ 371 Date: Sep. 7, 2005

(51) Int. Cl. B65G 43/06

(52) U.S. Cl. 198/810.02

(57) ABSTRACT

The invention concerns a conveyor belt arrestor, primarily for use with inclined conveyor belts, which operates to arrest the belt in the event that the belt breaks. The arrestor (10) of the invention has a frame (16) which is mounted in use to fixed structure of a conveyor belt installation. The frame includes a reaction member in the form of a beam (16.3) located above the top run of the belt (12). A wedging structure (18, 34, 44) is located beneath the top run of the conveyor bell and is mounted for swinging movement in a vertical plane relative to the frame. A torsion spring (42) is tensioned in use to apply a rotational bias to the wedging structure in a direction to swing it upwardly in the event of the belt breaking and belt tension being lost. This lifts the top run (12.1) of the belt towards the reaction member (16.3) such that the top run of the belt is trapped between the wedging structure and the reaction member by a wedging action that prevents movement of the top run of the belt in a direction opposite to its normal direction of forward travel.

### BACKGROUND TO THE INVENTION

This invention relates to a conveyor belt arrestor.

Conveyor belts periodically break, and such breakage usually results in a considerable amount of downtime. In the case of an inclined conveyor belt, breakage normally takes place in the vicinity of the head roller, with the result that the upper and lower runs of the belt tend to slip back under gravity over the idler rollers. The normal slippage of the belt is assisted by the stored tension in the unbroken belt which is released when the belt is broken. The result, if the broken belt is not arrested in some way, is that the broken belt slips back all the way to the lowest point. This is dangerous for nearby personnel and could possibly also cause considerable damage to the lower idlers and other stationery equipment. At the very least belt breakage in this situation results in considerable difficulty in re-establishing the correct position of the belt so that the break can be spliced.

Various devices have been proposed in the past to arrest a broken belt before it can slip back down the slope. For instance, WO01/055013 proposes a device in which, when belt tension is lost as a result of a break in the belt, counterweights swing a clamping member beneath the upper run of the belt upwardly so that the belt is clamped between a stationary cross-member and the clamping member. Somewhat similar arrangements, which also make use of counterweights, are described in SU 1467005 and SU 1219489. Serious disadvantages of such devices include the increased mass and cost attributable to the counterweights and the necessity to enclose the device in a safety cage in order to avoid possible injury to nearby personnel caused by the rapidly swinging counterweights. SU 179666 describes an arrangement in which the belt is clamped between a fixed cross-member and a clamping member which is driven to a clamping position, on loss of belt tension, by a spring-loaded sprocket. This device is considered to be unduly complicated and accordingly expensive.

### SUMMARY OF THE INVENTION

According to the present invention there is provided a conveyor belt arrestor comprising a frame mountable to fixed structure of a conveyor belt installation and including a reaction member located operatively above the top run of a conveyor belt of the installation, a wedging structure located operatively beneath the top run of the conveyor belt and mounted for swinging movement in a vertical plane relative to the frame, a torsion spring arranged to be tensioned ii use to apply a rotational bias to the wedging structure in a direction to swing the wedging structure upwardly, whereby in the event of the belt breaking and belt tension being lost, the torsion spring swings the wedging structure upwardly to lift the top run of the belt towards the reaction member such that the top run of the belt is trapped between the wedging structure and the reaction member by a wedging action that prevents movement of the top run of the belt in a direction opposite to its normal direction of forward travel.

Other novel features of the invention are defined in the appended claims.

One advantage of the use of a torsion spring arrangement as opposed to the previously proposed counterweight systems is the fact that the resulting mechanism is considerably more compact and lighter, which in turn means that the frame and other ancillary structures do not need to be as robust or massive. The use of a torsion spring arrangement is also considerably safer than a swinging counterweight system. Another advantage is the wedging action to arrest the belt. This is more secure than the conventional transverse clamping action where the possibility of belt slippage exists.

### BRIEF DESCRIPTION OF THE DRAWINGS

The invention will now be described in more detail, by way of example only, with reference to the accompanying drawings in which:

FIG. 1 shows a perspective view of a conveyor belt arrestor according to this invention;

FIG. 2 shows a plan view of the conveyor belt arrestor;

FIG. 3 shows a sectional side view of the arrestor during normal belt operation:

FIG. 4 shows a similar view of the arrestor after actuation to arrest the conveyor belt;

FIG. 5 shows a detail of the conveyor belt arrestor of the invention;

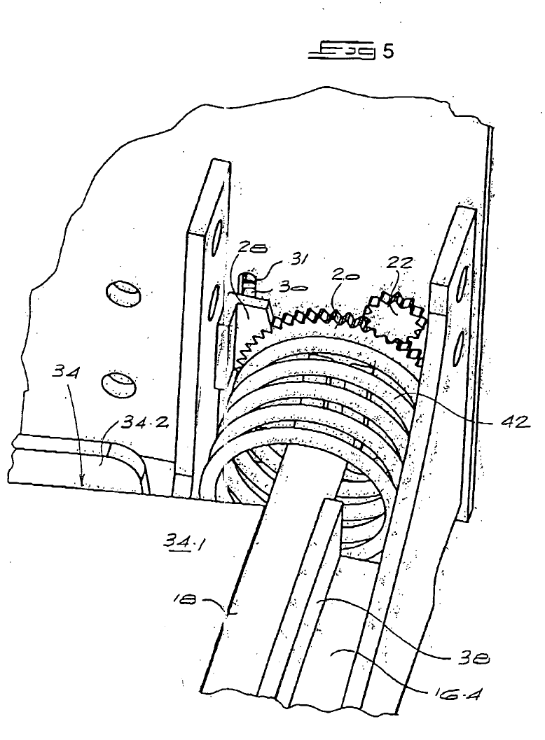

FIG. 6 shows the detail of FIG. 5 from a different angle;

FIG. 7 shows another detail of the conveyor belt arrestor; and

FIG. 8 shows a cross-sectional detail of one end of the roller carried by the arrestor structure support arm.

### DESCRIPTION OF THE ILLUSTRATED EMBODIMENT

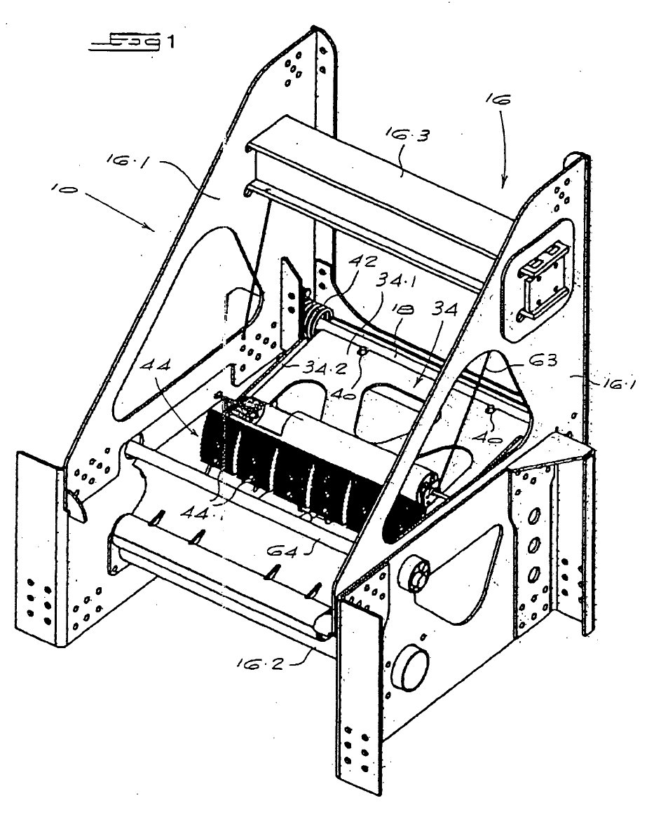

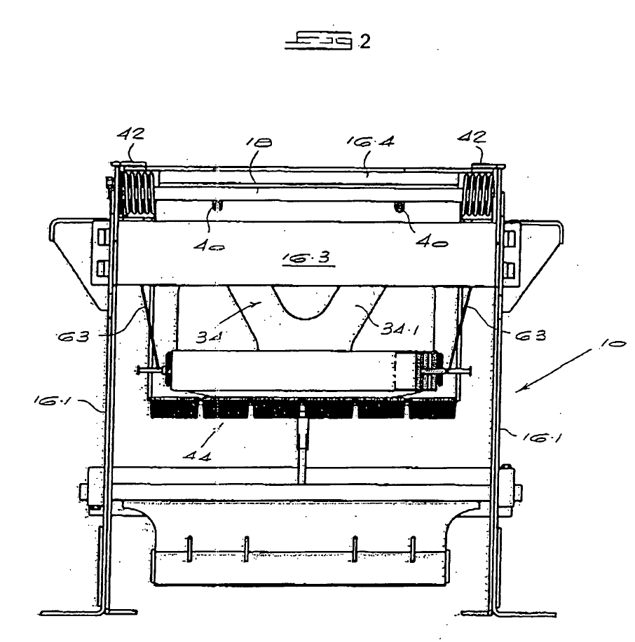

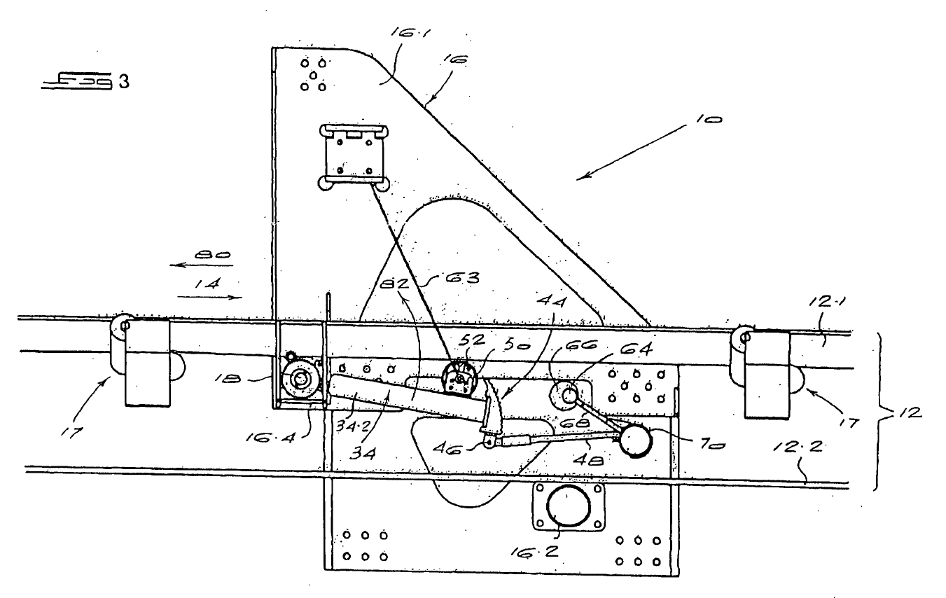

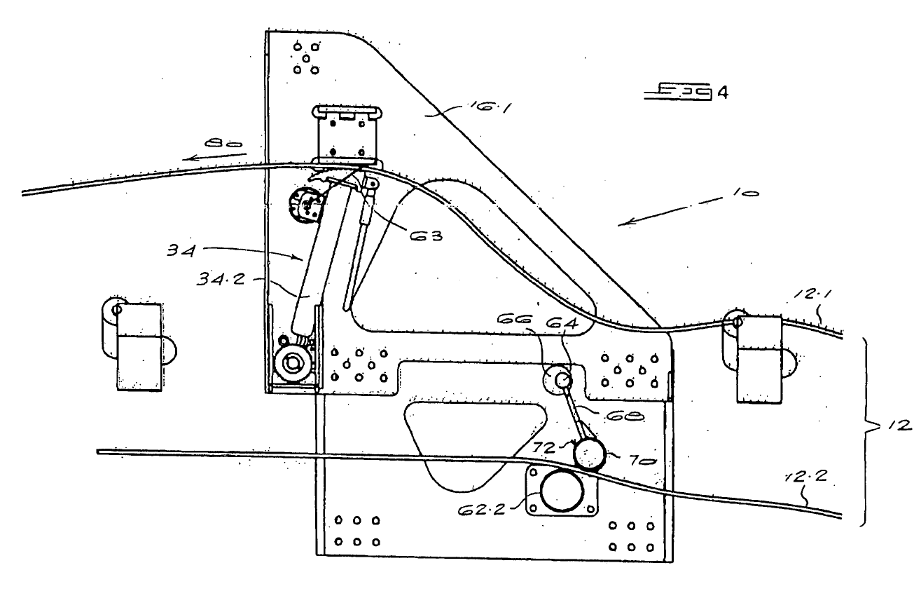

FIGS. 1 to 4 illustrate a conveyor belt arrestor 10 according to the invention. For clarity of illustration, the belt 12 itself is not shown in FIGS. 1 and 2. The upper and lower runs of the belt are indicated by the numerals 12.1 and 12.2 respectively in FIGS. 3 and 4. The direction of normal belt movement is indicated by the arrow 14. The orientation of the drawings shows the belt moving horizontally, but in the primary application of the invention the conveyor belt will be inclined relative to the horizontal, with the upper run of the belt moving upwardly at the incline angle.

As indicated previously, belt breakage normally takes place in the vicinity of the head roller (not shown) around which the belt 12 passes. For reasons which will emerge subsequently, the arrestor 10 is installed at a position close to and slightly below, i.e. slightly upstream, of the head roller.

The arrestor 10 includes a frame 16 which is connected to fixed structure (not shown) at the sides of the conveyor belt. The frame includes side plates 16.1 on either side of the belt 12, a tubular frame member 16.2 spanning between the side plates 16.1 beneath the lower run 12.2 of the belt, a reaction member in the form of a beam 16.3 spanning between the side plates some distance above the upper run 12.1 of the belt and a lower beam 16.4 also fixed to and spanning between the side plates 16.1.

As shown in FIG. 3 the upper run 12.1 of the belt is supported by troughed idlers 17 on either side of the arrestor.

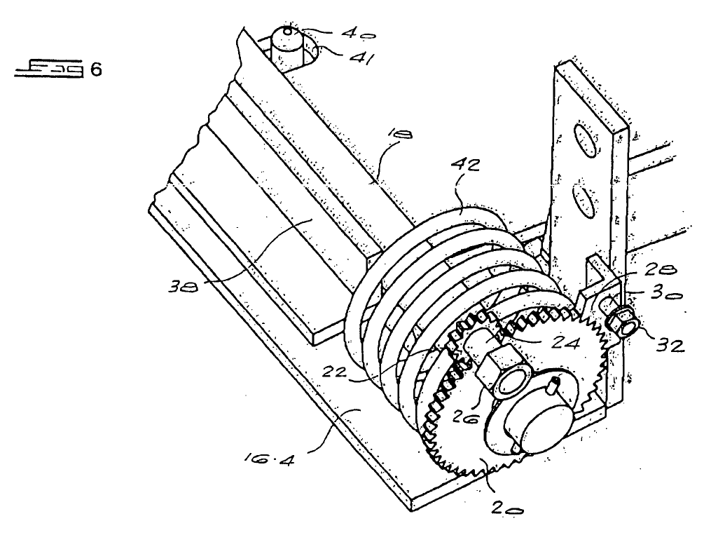

The arrestor 10 also includes a wedging structure incorporating a rotatable shaft 18 which extends transversely between the side plates 16.1 beneath the upper run of the belt. Mounted fast on the ends of the shaft 18, inside the side plates 16.1, are toothed sprockets 20. On each side a pinion 22 carried by a stub shaft 24 mates with the relevant sprocket 20. The stub shaft 24 projects outwardly through an opening in the adjacent side plate 16.1 and has a hexagonal head 26 as shown in FIG. 6. In FIG. 6, the side plate 16.1 has been omitted to enable the relevant components to be seen. A toothed detent 28 also engages with the sprocket 20. A threaded shank 30 projects laterally from the detent through a slot 31 in the side plate 16.1 and carries, outside the side plate, a nut 32. With the nut loose, the slot 31 allows the detent 28 to be raised out of engagement with the sprocket or lowered into engagement with the sprocket.

One edge of an arm 34, forming part of the wedging structure which is connected to the shaft 18. The arm includes a plate 34.1 and flat, vertically oriented bars 34.2 which are connected to and reinforce the opposite side edges of that plate.

The shaft 18 is located rotatably between a bar 38 which is connected on edge to the plate 16.4 and a pair of pins 40 which project upwardly from that plate. The bar 38 and pins 40 restrain the shaft 18 from moving backwards or forwards but allow the shaft to rotate freely. Referring for instance to FIG. 6 it will be seen that the plate 34.1 of the arm 34 is formed with cut-outs 41 in which the pins 40 can locate when the arm 34 is at the FIG. 3 orientation.

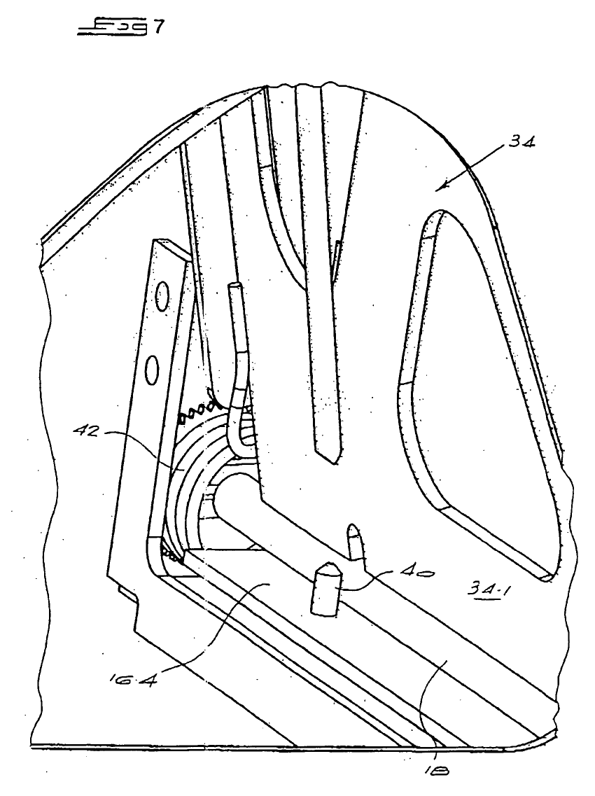

A coiled torsion spring 42 is located about each end of the shaft 18, inwardly of the sprocket 26. One end of the spring 42 is engaged with the lower beam 16.4 and the other end is located behind the plate 34.1, as seen in FIG. 7.

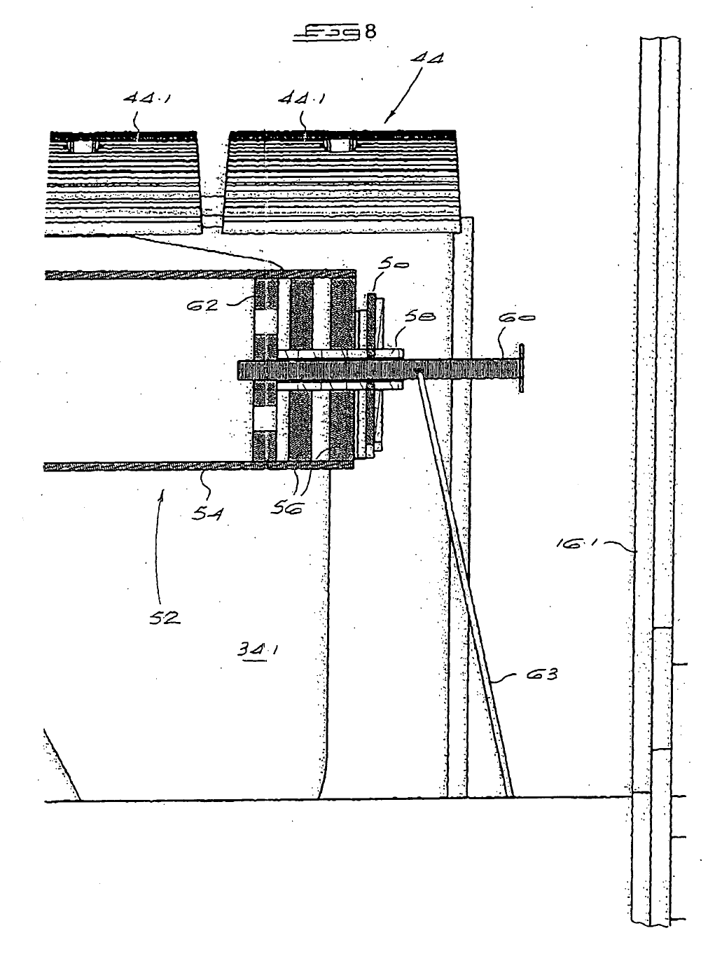

The opposite edge of the arm 34 carries an arrestor structure 44, also forming part of the wedging structure and composed of a series of wedge segments 44.1. Pivoted to a lug 46 on the structure 44 is a detent arm 48. Supported rotatably between lugs 50 on the arm 34, at a position adjacent the structure 44, is a roller 52 one end of which is seen in cross-section in FIG. 8. The roller 52 includes a tubular roller body 54 supported by roller bearings 56 on a tubular shaft 58 supported by the lugs 50. A sub-shaft 60 extends rotatably through the shaft 58 and is supported at its inner end relative to the roller by a unidirectional bearing 62. A cord 63 has one end attached to the sub-shaft 60 and its other end attached to the beam 16.3.

Each end of a transverse shaft 64 is supported in an eccentric opening in an element 66 mounted in the associated side plate 16.1. as shown in FIGS. 1, 3 and 4. The element 66 is rotatable relative to the side plate 16.1 but can be clamped relative to the side plate at any desired rotational position. One edge of an arm 68 in the form of a flat plate extends rigidly from the shaft 64 and carries, at its remote edge, a tubular bar 70. A lug 72 projects radially from the bar 70 as illustrated.

FIG. 3 shows the arrestor 10 of the invention during normal belt travel in the direction 14. After the belt has been installed, the torsion springs 42 are tensioned to a predetermined degree. In each case this is achieved, with the detent 28 raised away from the sprocket 20, by applying a torque spanner or the like to the hexagonal head 26 to rotate the head, stub shaft 24, pinion 22 and, accordingly, the sprocket 20. The torsion applied to the spring is in such a direction that the spring tends to urge the arm in a counterclockwise direction when viewed in FIG. 3, i.e. the spring is tensioned in a clockwise direction when viewed in that Figure. The same procedure is carried out on both sides of the arrestor 10, so that both springs store the same tension.

The underside of the top run 12.1 of the belt locates against the roller 52. The weight of the belt and, in use, the material which it carries, applies a downward force to the roller 52 and, accordingly, to the arm 34. This downward force, combine with effect of the tensioned belt, is sufficient to maintain the components in their FIG. 3 positions; i.e. to maintain the tension stored in the springs 42.

Referring to FIG. 3 it will be noted that in the normal operating position, the end of the detent arm 48 remote from the arrestor structure 44 is lodged between the lug 72 and the point at which the arm 68 is connected to the bar 70. In this position, the detent arm 48 holds the arm 68 and bar 70 in the positions seen in FIG. 3.

If the belt should break at a position close to the head roller, i.e. at a position to the right hand side of the arrestor 10 as viewed in FIGS. 3 and 4, there will be an immediate loss of tension in the upper run of the belt and at the same time, a tendency for the belt to slip down the slope, i.e. to the left in a direction 80 opposite to the arrow 14.

As soon as the belt loses tension, the tension stored in the springs 42 is sufficient to overcome the weight of the belt and any material remaining thereon. The springs cause the shaft 18 to rotate in a counterclockwise direction as viewed in FIG. 3, and this in turn causes the arm 34 to swing up rapidly in the direction of the arrow 82, lifting the top run 12.1 of the belt as it does so. The arrestor structure 44, i.e. the wedge segments 44.1, come into direct contact with the underside of the top run 12.1 and lift the belt off the roller 52. With further movement of the arm 34, the arrestor structure brings the upper surface of the top run 12.1 of the belt into contact with the underside of the team 16.3. The top run of the belt is accordingly trapped between the wedged segments and the beam and is prevented from slipping any further than it already has.

The wedge surfaces 44-2 of the wedge segments 44.1 and the arc through which those surfaces move in relation to the beam 16.3 as the arm swings ensures that a wedging action is applied to the top run of the belt, to ensure that it is securely trapped. From FIG. 4 it will be understood that any tendency of the belt to slip further in the direction 80 will merely result in more powerful wedging action to prevent such movement. This wedging action applied by the arrestor 10 when actuated is considered to be an important advantage of the invention when compared to prior arresting devices, such as that described in WO 01/055013, which merely apply a clamping action in a direction transverse to the belt.

It will also be understood that a competent wedging action can be achieved with a variety of different belt thicknesses.

As soon as the arm 34 commences its upward swinging movement, the end of the detent arm 48 dislodges from its FIG. 3 position and the detent arm is free to swing downwardly. At the same time, the arm 68 and bar 70 swing downwardly under gravity towards the tubular frame member 16.2. As shown in FIG. 4. the bottom run 12.2 of the belt 12 is trapped between the bar 70 and the tubular frame member 16.2, and any tendency for this run to slip downwardly in tire direction 80 is accordingly also resisted.

Given that the belt thickness may vary from installation to installation, facility is provided for adjusting the effective length of the arm 68 to ensure that the bottom run of the belt is properly trapped. As indicated above, the arm 68 is carried by the shaft 64 the ends of which locate rotatably in eccentric openings in the elements 66. By rotating the elements 66 relative to the side plates 16.1, the shaft 64 can be moved towards or away from the tubular frame member 16.2. The desired rotational position of the elements 66 for the belt thickness in question is set by clamping these elements relative to the side plates 16.1. thereby also setting the effective length of the arm 68 and the quality of the trapping action applied to the bottom run of the belt.

In another version of the invention, not illustrated, it is possible to replace the bar 70 with a wedging member having an action similar to that of the arrestor structure 44, i.e. so as to generate a wedging action to arrest the bottom run of the belt.

Throughout the time that the top run of the belt is running normally in the direction of the arrow 14, the roller 52 rotates freely because of the contact of the belt on the roller. The arrangement of the bearings 56 and 62 allows the sub-shaft 60 to rotate freely relative to the roller 52 so there is no tendency for the cord 63 to wind up on the sub-shaft. When the belt breaks and the top run 12.1 of the belt 12 starts to slip back, the roller 52 is rotated in the reverse direction. This causes the unidirectional bearing 62 to lock up. The sub-shaft 60 now rotates in unison with the roller. The cord 63 accordingly winds up on the sub-shaft. As the cord winds up its effective length decreases. The resulting tension in the cord pulls the arm 34 upwardly, thereby assisting the springs 42 to raise the arm and arrestor structure 44. The end result is shown in FIG. 4, where it will be understood that the cord has been almost fully wound up onto the sub-shaft 60.

The mechanism just described provides an effective back-up to the torsion springs, ensuring that the belt is property arrested by the described wedging action even if the springs should for any reason fail.

1-13. (canceled)

14. A conveyor belt arrestor comprising:
a frame mountable to a fixed structure of a conveyor belt installation, the frame including a reaction member located operatively above a top run of a conveyor belt of the installation;
a wedging structure located operatively beneath the top run of the conveyor belt and mounted for swinging movement in a vertical plane relative to the frame; and
at least one torsion spring arranged to be tensioned in use to apply a rotational bias to the wedging structure in a direction to swing the wedging structure upwardly;
wherein, in the event of the conveyor belt breaking and belt tension being lost, the at least one torsion spring swings the wedging structure upwardly to lift the top run of the conveyor belt toward the reaction member such that the top run of the conveyor belt is trapped between the wedging structure and the reaction member by a wedging action that prevents movement of the top run of the conveyor belt in a direction opposite to its normal direction of forward travel.

15. The conveyor belt arrestor of claim 14, wherein the wedging structure comprises an arm carried by a shaft rotatable relative to the frame and acted upon by the at least one torsion spring.

16. The conveyor belt arrestor of claim 15 comprising torsion springs acting on opposite ends of the shaft.

17. The conveyor belt arrestor of claim 14, wherein the wedging structure comprises a plurality of wedge-shaped segments.

18. The conveyor belt arrestor of claim 14, wherein the reaction member is a beam extending transversely over the conveyor belt between side structures of the frame.

19. The conveyor belt arrestor of claim 14 further comprising a trapping apparatus for trapping a bottom run of the conveyor belt in the event of belt breakage.

20. The conveyor belt arrestor of claim 19, wherein the trapping apparatus comprises:
a fixed frame member located operatively beneath the bottom run of the conveyor belt;
a trapping member located operatively above the bottom run of the conveyor belt and arranged to swing relative to the frame between an inoperative position clear of the bottom run of the conveyor belt and an operative position in which it traps the bottom run of the conveyor belt against the fixed frame member; and
a detent arranged to hold the trapping member in the inoperative position during normal conveyor belt operation and, in response to upward swinging movement of the wedging structure, to release the trapping member to swing downwardly under gravity to the operative position.

21. The conveyor belt arrestor of claim 20, wherein the trapping member is carried by an arm on a rotatable shaft, the effective distance between the shaft and the fixed frame member is adjustable to cater for different thicknesses of conveyor belt.

22. The conveyor belt arrestor of claim 21, wherein the rotatable shaft to which the arm carrying the trapping member is connected has ends which are rotatable in eccentric openings in members which are themselves rotatable relative to the frame to adjust the effective length of the arm.

23. The conveyor belt arrestor of claim 21, wherein the detent member comprises a detent arm having opposing ends, one end of which is pivoted to the wedging structure and the other end of which is engageable with the trapping member to hold the trapping member in the inoperative position during normal belt operation and which is arranged to disengage the trapping member when the wedging structure swings upwardly.

24. The conveyor belt arrestor-of claim 14 further comprising an auxiliary apparatus which acts in addition to the at least one torsion spring to swing the wedging structure upwardly in event of belt breakage and loss of belt tension.

25. The conveyor belt arrestor of claim 24, wherein the auxiliary apparatus comprises:
a roller supported rotatably by the frame and arranged to be rotated by the top run of the conveyor belt;
a sub-shaft on an axis of the roller which can rotate relative to the roller during normal belt operation but which is locked relative to the roller in the event of reverse movement of the conveyor belt and corresponding reverse rotation of the roller; and
a cord attached to the sub-shaft and to a point on the frame above the top run of the conveyor belt which is arranged to be wound up on the sub-shaft and thereby to raise the roller and with it the top run of the conveyor belt in the event of reverse rotation of the roller.

26. The conveyor belt arrestor of claim 24, further comprising a unidirectional bearing supporting the sub-shaft relative to the roller.

27. A conveyor belt arrestor comprising:
a frame mountable to a fixed structure of a conveyor belt installation, the frame including a reaction member located operatively above a top run of a conveyor belt of the installation;
a wedging structure located operatively beneath the top run of the conveyor belt and mounted for swinging movement in a vertical plane relative to the frame;
at least one torsion spring arranged to be tensioned in use to apply a rotational bias to the wedging structure in a direction to swing the wedging structure upwardly; and
a trapping apparatus for trapping a bottom run of the conveyor belt;
wherein, in the event of the conveyor belt breaking and belt tension being lost, the at least one torsion spring swings the wedging structure upwardly to lift the top run of the conveyor belt toward the reaction member such that the top run of the conveyor belt is trapped between the wedging structure and the reaction member by a wedging action that prevents movement of the top run of the conveyor belt in a direction opposite to its normal direction of forward travel.

28. The conveyor arrestor of claim 27, wherein the trapping apparatus comprises:
a fixed frame member located operatively beneath the bottom run of the conveyor belt;
a trapping member located operatively above the bottom run of the conveyor belt and arranged to swing relative to the frame between an inoperative position clear of the
a detent arranged to hold the trapping member in the inoperative position during normal conveyor belt operation and, in response to upward swinging movement of the wedging structure, to release the trapping member to swing downwardly under gravity to the operative position.

29. The conveyor belt arrestor of claim 28, wherein the trapping member is carried by an arm on a rotatable shaft, the effective distance between the shaft and the fixed frame member is adjustable to cater for different thicknesses of conveyor belt.

30. The conveyor belt arrestor of claim 29, wherein the rotatable shaft to which the arm carrying the trapping member is connected has ends which are rotatable in eccentric openings in members which are themselves rotatable relative to the frame to adjust the effective length of the arm.

31. A conveyor belt arrestor comprising:
a frame mountable to a fixed structure of a conveyor belt installation, the frame including a reaction member located operatively above a top run of a conveyor belt of the installation;
a wedging structure located operatively beneath the top run of the conveyor belt and mounted for swinging movement in a vertical plane relative to the frame;
at least one torsion spring arranged to be tensioned in use to apply a rotational bias to the wedging structure in a direction to swing the wedging structure upwardly;
an auxiliary apparatus, acting in addition to the at least one torsion spring, to swing the wedging structure upwardly; and
a trapping apparatus for trapping a bottom run of the conveyor belt including a fixed frame member located operatively beneath the bottom run of the conveyor belt, a trapping member located operatively above the bottom run of the conveyor belt and a detent trapping member located operatively above the bottom run of the conveyor belt and a detent arranged to hold the trapping member in an inoperative position during normal belt operation;
wherein, in the event of the conveyor belt breaking and belt tension being lost, the at least one torsion spring and the auxiliary apparatus swings the wedging structure upwardly to lift the top run of the conveyor belt toward the reaction member such that the top run of the conveyor belt is trapped between the wedging structure and the reaction member by a wedging action that prevents movement of the top run of the conveyor belt in a direction opposite to its normal direction of forward travel and the trapping apparatus swings downwardly under gravity in response to the upward swinging movement of the wedging structure to trap the bottom run of the conveyor belt between the trapping member and the fixed frame member.

32. The conveyor belt arrestor of claim 31, wherein the auxiliary apparatus comprises:
a roller supported rotatably by the frame and arranged to be rotated by the top run of the conveyor belt;
a sub-shaft on an axis of the roller which can rotate relative to the roller during normal conveyor belt operation but which is locked relative to the roller in the event of reverse movement of the conveyor belt and corresponding reverse rotation of the roller; and
a cord attached to the sub-shaft and to a point on the frame above the top run of the belt which is arranged to be wound up on the sub-shaft and thereby to raise the roller and with it the top run of the conveyor belt in the event of reverse rotation of the roller.

33. The conveyor belt arrestor of claim 31, wherein the detent comprises a detent arm having opposing ends, one end of which is pivoted to the wedging structure and the other end of which is engageable with the trapping member to hold the trapping member in an inoperative position during normal belt operation and which is arranged to disengage the trapping member when the wedging structure swings upwardly.
